(19) United States
(12) Patent Application Publication
(10) Pub. No.: US 2017/0230786 A1
(43) Pub. Date: Aug. 10, 2017

(54) TRACKING A PLURALITY OF ASSOCIATED REGISTERED USERS TO COMMUNICATE WITH A SELECTED ASSOCIATED REGISTERED USER WITHIN THE VICINITY OF A PERSON IN DISTRESS DURING AN EMERGENCY SITUATION

(71) Applicant: Magnasoft Consulting India Private Limited, Bengaluru (IN)

(72) Inventors: Shyam Ramamurthy, Bengaluru (IN); Bobbie H Kalra, Bengaluru (IN)

(21) Appl. No.: 15/236,244

(22) Filed: Aug. 12, 2016

(30) Foreign Application Priority Data
Feb. 5, 2016 (IN) 201641004284

(51) Int. Cl. H04W 4/02; H04W 4/22

(52) U.S. Cl. CPC H04W 4/02; H04W 4/22

(57) ABSTRACT

A system for tracking locations of a plurality of associated registered user devices within a vicinity of a location of a target registered user device held by a person in distress during an emergency situation is disclosed. The system includes a memory unit and a processor that executes a set of modules that includes a relative distance calculation module 306, a vicinity graph module 308, and a selected associated registered user information communication module 312. The relative distance calculation module 306 calculates the distances between the plurality of associated registered user devices within the vicinity of the target registered user device 104. The vicinity graph module 308 generates a graphical representation of the vicinity map showing the target registered user device 104 location, locations of the plurality of associated registered users, and the distance between the target registered user device 104 and the plurality of associated registered users.

### CROSS-REFERENCE TO RELATED APPLICATIONS

This application claims priority to Indian Patent Application number 201641004284 filed on Feb. 5, 2016, the complete disclosure of which, in its entirely, is herein incorporated by reference.

### BACKGROUND

Technical Field

The embodiments herein generally relate to field of location-based services, and more particularly the embodiments relate to a system and method for tracking and display of locations of associated registered users within the vicinity of a person in distress during an emergency situation.

Description of the Related Art

Safety of our loved ones is a major concern. Mobile phones can be used for communication to let loved ones know about one's whereabouts. However during an emergency situation, the time one has in hand to act is limited and of essence. When someone is in a distress situation, it is critical for their loved ones to know their location. Further, it may not be possible for the loved one to reach the person in distress in time, so they may want to reach out to a trusted person who is closer to the person in distress. This is particularly applicable in the case of children and parents. Typically, schools do not allow children to carry mobile phones to school, and so children will not be able to communicate with their parents and parents will not be able to know the whereabouts of their children. Also, if a parent becomes aware of the current location of their child but is not able to reach out to them in time, they need to reach out to someone nearer to the child for help.

Therefore, in light of the foregoing discussion, there remains a need for a system to enable loved ones to quickly reach out to trusted persons within the vicinity of a person in distress during an emergency situation.

### SUMMARY

The present disclosure seeks to provide one or more non-transitory computer readable storage mediums storing one or more sequences of instructions, which when executed by one or more processors, causes tracking a location of a plurality of associated registered users seeking help during an emergency situation, by performing steps of receiving a request to identify a location of a target registered user device from at least one of (i) a primary emergency user device, or (ii) a secondary emergency user device when (i) said primary emergency user device, or (ii) the secondary emergency user device receives a message from the target registered user device, obtaining the location of the target registered user device, calculating a plurality of distances of a plurality of associated registered user devices associated with a plurality of associated registered users from the location of the target registered user device, generating a graphical representation that consists of (a) the location of the target registered user device, (b) locations of the plurality of associated registered user devices associated with the plurality of associated registered users, (c) distances of the plurality of associated registered user devices associated with the plurality of associated registered users from the location of the target registered user device, (d) names of the plurality of associated registered users, communicating the graphical representation to at least one of (i) the primary emergency user device, or (ii) the secondary emergency user device, obtaining a selection of at least one selected associated registered user from the plurality of associated registered users, based on a selection corresponding to a location of the selected associated registered user on the graphical representation on at least one of (i) the primary emergency user device, or (ii) the secondary emergency user device, and obtaining a contact information of the selected associated registered user.

The present disclosure seeks to provide a server for tracking a location of a plurality of associated registered user devices held by a plurality of associated registered users within a vicinity of a location of a target registered user device held by a person in distress to communicate with an associated registered user within said vicinity during an emergency situation, wherein said server comprises a server memory that stores an associated registered user database, and a first set of modules, wherein said associated registered user database stores contact information of a plurality of associated registered users who are associated with target users and a server processor that executes said first set of modules. The first set of modules comprises a target registered user location obtaining module implemented by said server processor that obtains a location of said target registered user device on receiving an emergency indication from said target registered user device an associated registered user location obtaining module implemented by said server processor that periodically obtains locations of a plurality of associated registered users associated with a plurality of target registered users, wherein said target registered users and said associated registered users are registered with said server a relative distance calculation module implemented by said server processor that calculates a plurality of distances of said plurality of associated registered user devices in a vicinity of said location of said target registered user device, a vicinity graph module implemented by said server processor that generates a graphical representation of locations of registered users in said vicinity of said target registered user device. The vicinity graph module comprises a target registered user location representation module implemented by said server processor that displays said location of said target registered user device on said graphical representation, a registered users location module implemented by said server processor that displays locations of said plurality of associated registered user devices on said graphical representation and a registered users distance calculation module implemented by said server processor that calculates a plurality of distances of said plurality of associated registered user devices from said location of said target registered user device on said graphical representation. A graphical representation communication module that communicates said graphical representation to at least one of (i) a primary emergency associated registered user device associated with said target registered user, or (ii) a secondary emergency associated registered user device associated with said target registered user and a selected associated registered user information communication module that obtains a selection of at least one selected associated registered user from said plurality of associated registered users within said vicinity, based on a selection corresponding to said location of said selected associated registered user on said graphical representation on at least one of (i) said primary emergency user device, or (ii) said secondary emergency user device, and communicates a contact information of said selected associated registered user to at least one of said (i) primary emergency user device, or (ii) secondary emergency user device to enable placing a call to said selected associated registered user.

The present disclosure seeks to provide a primary emergency user device for tracking a location of a plurality of associated registered users to seek help during an emergency situation of a person in distress, comprising a distress signal obtaining module that obtains a message from a target registered user device, a person in distress location information requesting module that communicates a request to a server to identify a location of said target registered user device, wherein said location is updated at periodic interval, a person in distress location information obtaining module that obtains said location of said person in distress from said server at periodic intervals, and a graphical representation module that displays a graphical information that is obtained from said server, said information of said plurality of associated registered users to seek help from said plurality of associated registered users when said person in distress is in said emergency situation, wherein said information of said plurality of associated registered users comprise at least one of (a) a contact information of said plurality of associated registered users, (b) locations of said plurality of associated registered users, and (c) a distance between said plurality of associated registered users and said target registered user device.

Embodiments of the present disclosure substantially eliminate or at least partially address the aforementioned problems in the prior art, and provide a mechanism for authorized registered users to reach out to a person in distress who is requesting for help in a much faster and quicker way.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated using identical numbers.

Embodiments of the present disclosure will now be described, by way of example only, with reference to the following diagrams wherein:

FIG. 1 illustrates a system view of a a target registered user device communicating a distress signal to an emergency contact device through a network according to an embodiment herein;

FIG. 2 illustrates an exploded view of a primary emergency user device FIG. 1 according to an embodiment herein;

FIG. 3 illustrates an exploded view of a server of FIG. 1 according to an embodiment herein;

FIG. 4 illustrates a user interface view of a graphical representation module of the primary emergency user device of FIG. 1 according to an embodiment herein;

FIG. 5 is a flow diagram that illustrates a method of tracking a location of a plurality of associated registered users seeking help during an emergency situation according to an embodiment herein;

FIG. 6 is an interaction diagram illustrating a process of the person in distress interacting with the primary emergency user device through the server during an emergency situation according to an embodiment herein;

FIG. 7 illustrates an exploded view of the primary emergency user device of FIG. 1 according to an embodiment herein; and

FIG. 8 illustrates a schematic diagram of a computer architecture used according to the embodiments herein.

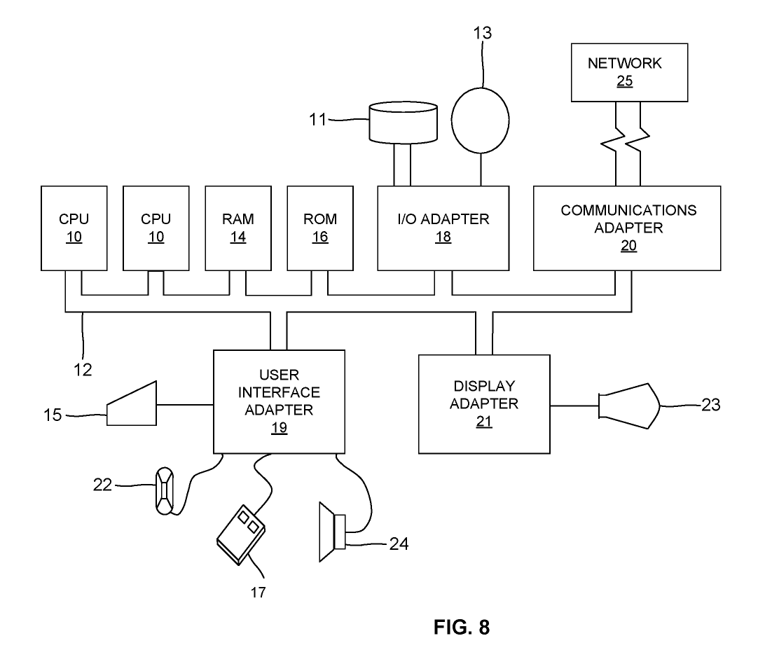

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is point

### DETAILED DESCRIPTION OF EMBODIMENTS

The following detailed description illustrates embodiments of the present disclosure and ways in which they may be implemented. Although some modes of carrying out the present disclosure have been disclosed, those skilled in the art would recognize that other embodiments for carrying out or practicing the present disclosure are also possible.

In one aspect, one or more non-transitory computer readable storage mediums storing one or more sequences of instructions, which when executed by one or more processors, causes tracking a location of a plurality of associated registered users seeking help during an emergency situation, by performing steps of receiving a request to identify a location of a target registered user device from at least one of (i) a primary emergency user device, or (ii) a secondary emergency user device when (i) said primary emergency user device, or (ii) the secondary emergency user device receives a message from the target registered user device, obtaining the location of the target registered user device, calculating a plurality of distances of a plurality of associated registered user devices associated with a plurality of associated registered users from the location of the target registered user device, generating a graphical representation that consists of (a) the location of the target registered user device, (b) locations of the plurality of associated registered user devices associated with the plurality of associated registered users, (c) distances of the plurality of associated registered user devices associated with the plurality of associated registered users from the location of the target registered user device, (d) names of the plurality of associated registered users, communicating the graphical representation to at least one of (i) the primary emergency user device, or (ii) the secondary emergency user device, obtaining a selection of at least one selected associated registered user from the plurality of associated registered users, based on a selection corresponding to a location of the selected associated registered user on the graphical representation on at least one of (i) the primary emergency user device, or (ii) the secondary emergency user device, and obtaining a contact information of the selected associated registered user.

In another aspect, a server for tracking a location of a plurality of associated registered user devices held by a plurality of associated registered users within a vicinity of a location of a target registered user device held by a person in distress to communicate with an associated registered user within said vicinity during an emergency situation, wherein said server comprises a server memory that stores an associated registered user database, and a first set of modules, wherein said associated registered user database stores contact information of a plurality of associated registered users who are associated with target users and a server processor that executes said first set of modules. The first set of modules comprises a target registered user location obtaining module implemented by said server processor that obtains a location of said target registered user device on receiving an emergency indication from said target registered user device an associated registered user location obtaining module implemented by said server processor that periodically obtains locations of a plurality of associated registered users associated with a plurality of target registered users, wherein said target registered users and said associated registered users are registered with said server a relative distance calculation module implemented by said server processor that calculates a plurality of distances of said plurality of associated registered user devices in a vicinity of said location of said target registered user device, a vicinity graph module implemented by said server processor that generates a graphical representation of locations of registered users in said vicinity of said target registered user device. The vicinity graph module comprises a target registered user location representation module implemented by said server processor that displays said location of said target registered user device on said graphical representation, a registered users location module implemented by said server processor that displays locations of said plurality of associated registered user devices on said graphical representation and a registered users distance calculation module implemented by said server processor that calculates a plurality of distances of said plurality of associated registered user devices from said location of said target registered user device on said graphical representation. A graphical representation communication module that communicates said graphical representation to at least one of (i) a primary emergency associated registered user device associated with said target registered user, or (ii) a secondary emergency associated registered user device associated with said target registered user and a selected associated registered user information communication module that obtains a selection of at least one selected associated registered user from said plurality of associated registered users within said vicinity, based on a selection corresponding to said location of said selected associated registered user on said graphical representation on at least one of (i) said primary emergency user device, or (ii) said secondary emergency user device, and communicates a contact information of said selected associated registered user to at least one of said (i) primary emergency user device, or (ii) secondary emergency user device to enable placing a call to said selected associated registered user.

In one embodiment, the server as claimed in claim 1, wherein the target registered user device enables the person in distress to communicate with at least one of (i) the plurality of devices, (ii) the primary emergency user device, or (iii) the secondary emergency user device by sending a voice message.

In another embodiment, the server as claimed in claim 1, further comprising communicating said location of said target registered user device on receiving said emergency indication from said target registered user device when said call to said selected associated registered user is placed from at least one of (i) said primary emergency user device, or (ii) said secondary emergency user device.

In another embodiment, the server as claimed in claim 1, wherein (i) a message, or (ii) a reply message comprises at least one of (a) a SOS call, (b) a text message, (c) a voice message, or (d) a push message.

In another aspect, the present disclosure seeks to provide a primary emergency user device for tracking a location of a plurality of associated registered users to seek help during an emergency situation of a person in distress, comprising a distress signal obtaining module that obtains a message from a target registered user device, a person in distress location information requesting module that communicates a request to a server to identify a location of said target registered user device, wherein said location is updated at periodic interval, a person in distress location information obtaining module that obtains said location of said person in distress from said server at periodic intervals, and a graphical representation module that displays a graphical information that is obtained from said server, said information of said plurality of associated registered users to seek help from said plurality of associated registered users when said person in distress is in said emergency situation, wherein said information of said plurality of associated registered users comprise at least one of (a) a contact information of said plurality of associated registered users, (b) locations of said plurality of associated registered users, and (c) a distance between said plurality of associated registered users and said target registered user device.

In an embodiment, the primary emergency user device of claim 5, wherein the message comprises at least one of (a) a voice call, (b) a SOS call, (c) a SMS, or (d) a push message.

According to one embodiment, the primary emergency user device of claim 5, wherein an alarm continuously sounds on the primary emergency user device until the alarm is dismissed by a primary emergency contact.

According to another embodiment, the primary emergency user device of claim 5, wherein the primary emergency user device comprises any one of (i) a mobile phone, (ii) a Smartphone, (iii) a personal computer, (iv) a tablet, or (v) a notebook.

According to another embodiment, the primary emergency user device of claim 5, wherein the message is immediately transferred to a secondary emergency user device when the primary emergency contact does not receive the call.

According to another embodiment, primary emergency user device of claim 5, wherein the server comprises a server memory that stores an associated registered user database, and a first set of modules, wherein said associated registered user database stores contact information of a plurality of associated registered users who are associated with target users and a server processor that executes said first set of modules The first set of modules comprises a target registered user location module implemented by said server processor that obtains a location of said target registered user device on receiving an emergency indication from said target registered user device, an associated registered user location obtaining module implemented by said server processor that periodically obtains locations of a plurality of associated registered users associated with a plurality of target registered users, wherein said target registered users and said associated registered users are registered with said server, a relative distance calculation module implemented by said server processor that calculates a plurality of distances of said plurality of associated registered user devices in a vicinity of said location of said target registered user device, a vicinity graph module implemented by said server processor that generates a graphical of locations of registered user in said vicinity of said target registered user device, a graphical representation communication module that communicates said graphical representation to at least one of (i) a primary emergency associated registered user device associated with said target registered user, or (ii) a secondary emergency associated registered user device associated with said target registered user, and a selected associated registered user information communication module that obtains a selection of at least one selected associated registered user from said plurality of associated registered users within said vicinity, based on a selection corresponding to said location of said selected associated registered user on said graphical representation on at least one of (i) said primary emergency user device, or (ii) said secondary emergency user device, communicates a contact information of said selected associated registered user to at least one of said (i) primary emergency user device, or (ii) secondary emergency user device to enable placing a call to said selected associated registered user.

In another embodiment, the primary emergency user device of claim 10, wherein said graphical representation modules comprises a target registered user location representation module implemented by said server processor that displays said location of said target registered user device on said graphical representation, a registered users location module implemented by said server processor that displays locations of said plurality of associated registered user devices on said graphical representation, and a registered users distance calculation module implemented by said server processor that calculates a plurality of distances of said plurality of associated registered user devices from said location of said target registered user device on said graphical representation.

In another embodiment, the primary emergency user device of claim 5, wherein (i) a message, or (ii) a reply message comprises at least one of (a) a SOS call, (b) a text message, (c) a voice message, or (d) a push message.

### DETAILED DESCRIPTION OF THE DRAWINGS

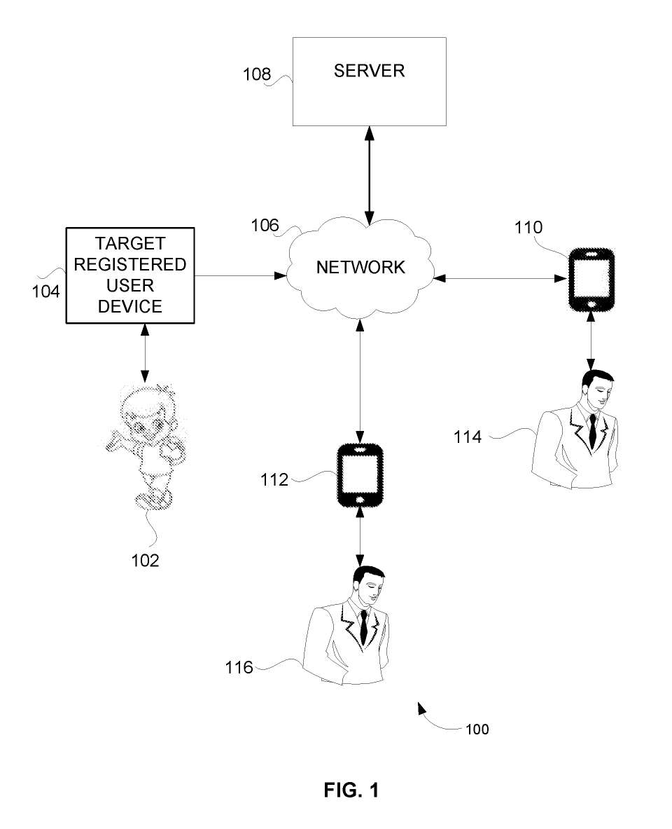

FIG. 1 illustrates a system view 100 of a target registered user device 104 communicating a distress signal to an emergency contact device through a network 108 according to an embodiment herein. The system view 100 includes a person in distress (e.g., a child) 102, the target registered user device 104 held or worn by the person in distress, the network 106, a server 108, a primary emergency user device (e.g., a parent's mobile phone) 110, a secondary emergency user device 112, a primary emergency contact 114, and a secondary emergency contact 116. In one embodiment, the target registered user device 104 may be a wearable device (e.g., a watch) that has its own in built SIM. In an emergency situation, the person in distress 102 may reach out for help to the server 108 or to the primary emergency contact 114 and secondary emergency contact 116 for urgent help. In one embodiment, the person in distress 102 presses on the SOS button and calls are immediately made to a primary emergency contact 114 and a secondary emergency contact 116, in case the primary emergency contact 114 does not answer the call. In another embodiment, calls can only be made to the parent emergency contact 114 and the secondary emergency contact 116 and not to other contacts, in the contact list of the target registered user device 104.

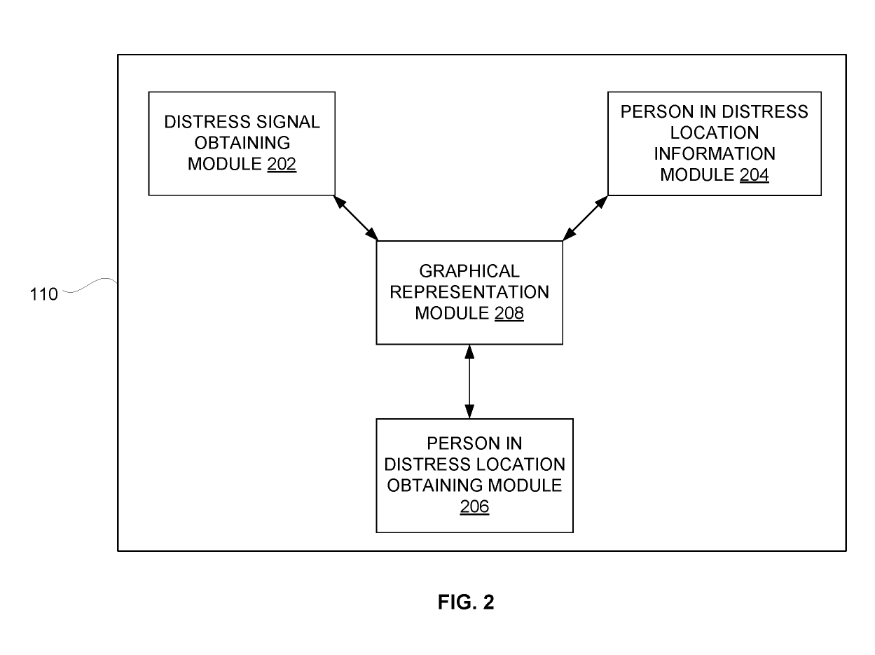

FIG. 2 illustrates an exploded view 200 of a primary emergency user device 110 FIG. 1 according to an embodiment herein. The exploded view 200 includes a distress signal obtaining module 202, a person in distress location information module 204, a person in distress location obtaining module 206, and a graphical representation module 208. The distress signal obtaining module 202 obtains a message from the target registered user device 104. The person in distress location information module 204 communicates a request to the server 108 to identify a location of the target registered user device 104.

The graphical representation module 208 displays graphical information obtained from the server 108 and also displays information on a plurality of associated registered users whom can be reached out to help the person in distress 102. In one embodiment, the primary emergency contact 114 and the secondary emergency contact 116 views at least one of the following information (a) a contact information of said plurality of associated registered users, (b) locations of said plurality of associated registered users, and (c) a distance between said plurality of associated registered users and said target registered user device 104.

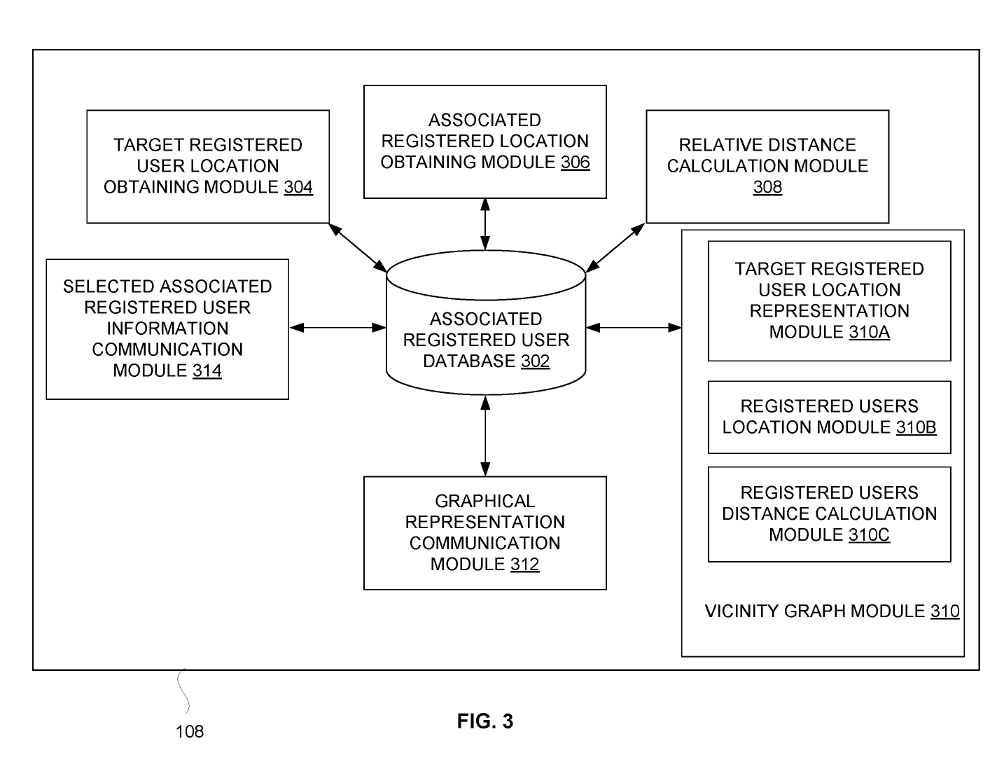

FIG. 3 illustrates an exploded view 300 of a server 108 of FIG. 1 according to an embodiment herein. The exploded view 300 includes an associated registered user database 302, a target registered user location obtaining module 304, an associated registered location obtaining module 306, a relative distance calculation module 308, a vicinity graph module 310, a graphical representation communication module 312, and a selected associated registered user information communication module 314. The associated registered user database 302 stores contact information of a plurality of associated registered users who are associated with target users. The target registered user location module 304 obtains the current location of the target registered user device 104 on receiving an emergency indication from said target registered user device 104. The associated registered location obtaining module 306 periodically obtains locations of the plurality of associated registered users, where the plurality of associated registered users are registered with the server 108. The relative distance calculation module 306 calculates a plurality of distances of a plurality or associated registered devices in a vicinity of the location of the target registered user device 104. In one embodiment, the plurality of associated registered users within the vicinity of that target registered user device 104 is obtained based on the current location, the time taken to reach the target registered user device 104 location, and the current condition of the plurality of associated registered users. For example, the current condition could be driving, walking etc.

The vicinity graph module 308 generates a graphical representation of locations of the plurality of associated registered users in the vicinity of the target registered user device 104. In one embodiment, the vicinity graph modules 308 includes a target registered user location representation module 308A, a registered users location module 308B, and a registered users distance calculation module 308C. The target registered user location representation module 308A displays the location of the target registered user device 104 on the graphical representation. The registered users location module 308B displays locations of the plurality of associated registered user devices on the graphical representation. The registered users distance calculation module 308C calculates a plurality of distances of the plurality of associated registered user devices from the location of said target registered user device 104 on the graphical representation.

The graphical representation communication module 312 communicates the graphical representation to at least one of (i) the primary emergency user device, or (ii) the secondary emergency user device. The selected associated registered user information communication module 314 obtains a selection of at least one selected associated registered user from the plurality of associated registered users, based on a selection corresponding to the location of the selected associated registered user on the graphical representation on at least one of (i) the primary emergency user device 110, or (ii) the secondary emergency user device 112, communicating a contact information of said selected associated registered user to at least one of the (i) primary emergency user device 110, or (ii) secondary emergency user device 112.

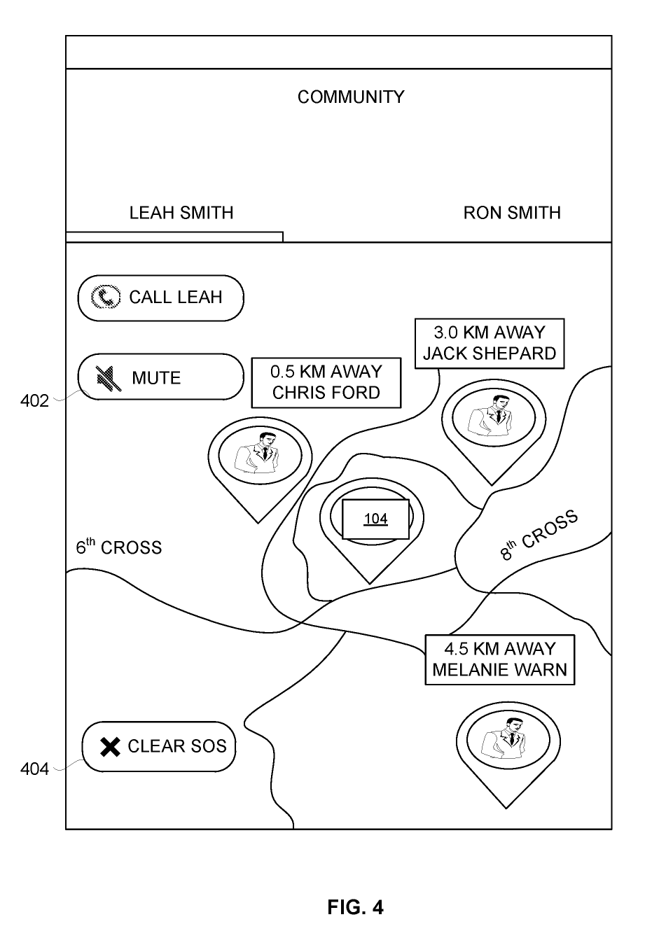

FIG. 4 illustrates a user interface view 400 of a graphical representation module 208 of the primary emergency user device 110 of FIG. 1 according to an embodiment herein. The user interface view 400 includes a mute button 402 and a clear SOS button 404. The mute button 402 is to be pressed so that the continuously sounding alarm stops sounding. In one embodiment, the primary emergency contact 114 or secondary emergency contact 116 has the option of pressing the clear SOS button 404 when they are notified that the person in distress 102 is safe and pressing the clear SOS button 404 will immediately close the community screen. In another embodiment, this screen also shows the target registered user device 104 location and the names and locations of the plurality of associated registered users.

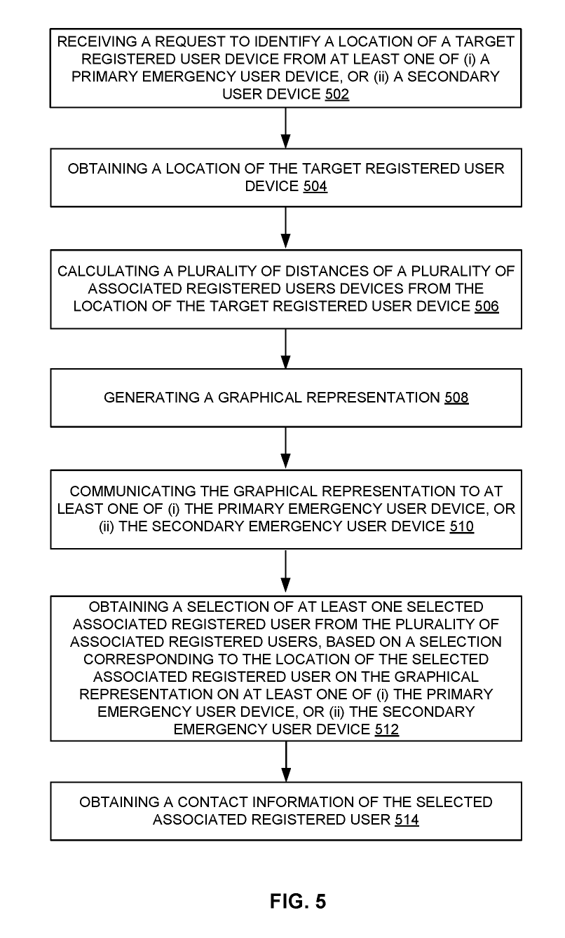

FIG. 5 is a flow diagram 500 that illustrates a method of tracking a location of a plurality of associated registered users seeking help during an emergency situation according to an embodiment herein. At step 502, a request to identify the location of the target registered user device 104 is received from at least one of (i) the primary emergency contact device 110, or (ii) the secondary emergency contact device 112. At step 504, the location of the target registered user device 104 is obtained. At step 506, a plurality of distances of the plurality of associated registered users is calculated based on the location of the target registered user device 104.

At step 508, the graphical representation of the vicinity map is generated. The graphical representation includes (a) the location of the target registered user device 104, (b) locations of the plurality of associated registered user devices associated with the plurality of associated registered users, (c) distances of the plurality of associated registered user devices associated with the plurality of associated registered users from the location of the target registered user device 104, and (d) names of the plurality of associated registered users. At step 510, the graphical representation is communicated to at least one of (i) the primary emergency user device 110, or (ii) the secondary emergency user device 112. At step 512, a selection of at least one selected associated registered user is obtained, from the plurality of associated registered users. At step 514, a contact information of the selected associated registered user is obtained.

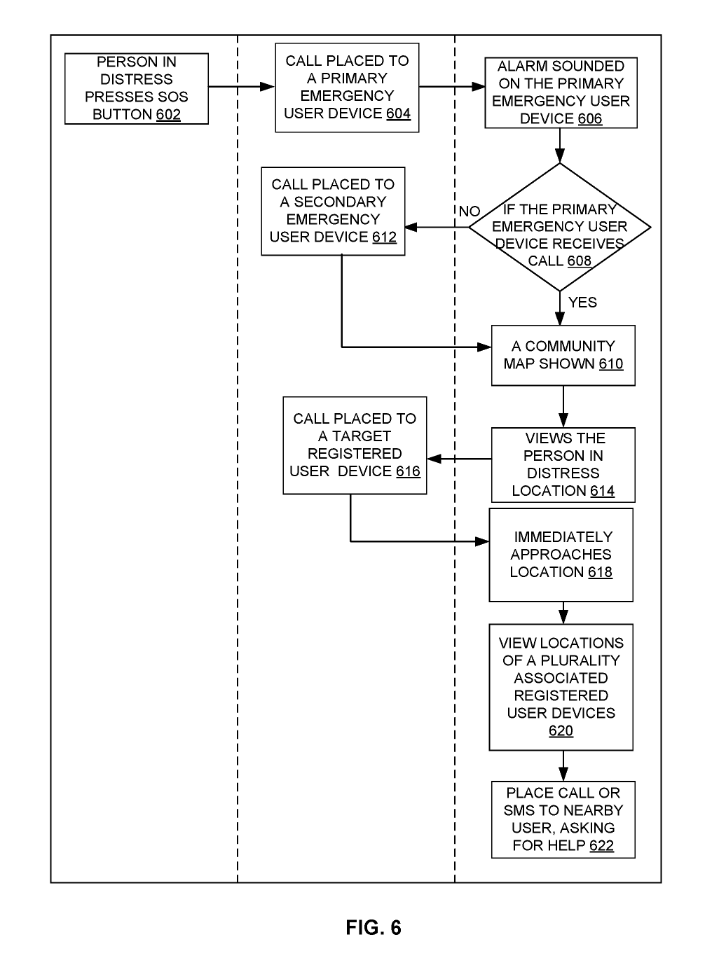

FIG. 6 is an interaction diagram 600 illustrating a process of the person in distress 102 interacting with the primary emergency user device 110 through the server 108 during an emergency situation according to an embodiment herein. At step 602, the person in distress 102 presses the SOS button on the target registered user device 104 during an emergency situation. At step 604, a call is placed to the primary emergency user device 110. A call is immediately transferred to the primary emergency contact 114 first from the target registered user device 104, so the person in distress 102 does not have to spend time in browsing the contact list for his/her emergency contact. At step 606, an alarm is immediately sounded on the primary emergency user device 110. The alarm will keep on sounding on the parent primary emergency user device 110 until he/she clicks on the mute button 402. At step 608, checking whether the primary emergency contact 114 has answered the call. In one embodiment, at step 610, a vicinity map is immediately opened. In another embodiment, at step 612, the target registered user device 104 places a call to the secondary emergency user device 112, just in case the primary emergency contact 114 is not receiving the call.

At step 614, the primary emergency contact 114 can view the location of the target registered user device 104. At step 616, the primary emergency contact 114 immediately places a call to the target registered user device 104. At step 618, the primary emergency contact 114 immediately approaches the location the person in distress 102. At step 620, the primary emergency contact 114 can view at least one of (a) a contact information of the plurality of associated registered users, (b) locations of the plurality of associated registered users, and (c) a distance between the plurality of associated registered users and the target registered user device 104. At step 622, the primary emergency contact 114 can place a call or either send an SMS to the selected associated registered user. In one embodiment, the plurality of associated registered users may be a policemen, firemen, driver. However it is necessary for the selected associated registered user to be registered within the network, otherwise their location and contact details will not be displayed on the graphical representation. The primary emergency contact 114 or secondary emergency contact 116 can then be notified when the selected associated registered user reaches the current location of the person in distress 102.

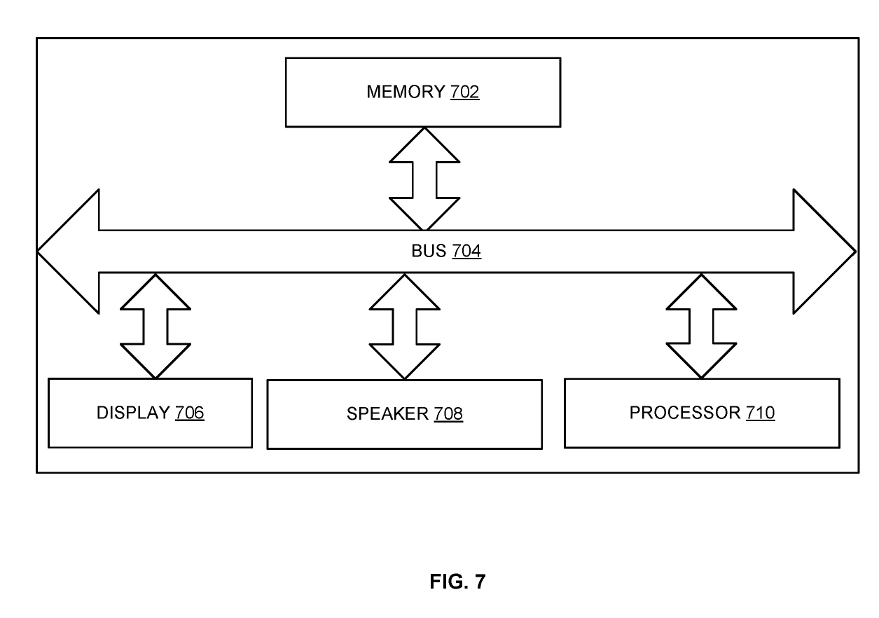

FIG. 7 illustrates an exploded view 700 of the primary emergency user device 110 of FIG. 1 according to an embodiment herein. The exploded view 700 includes a memory 702 having a set of instructions, a bus 704, a display 706, a speaker 708, and a processor 710 capable of processing the set of instructions to perform any one or more of the methodologies herein, according to an embodiment herein. The processor 710 may also enable digital content to be consumed in the form of video for output via one or more displays 706 or audio for output via speaker and/or earphones 708. The processor 710 may also carry out the methods described herein and in accordance with the embodiments herein.

Digital content may also be stored in the memory 702 for future processing or consumption. The memory 702 may also store program specific information and/or service information (PSI/SI), including information about digital content (e.g., the detected information bits) available in the future or stored from the past. A user of the exploded 700 may view this stored information on display 706 and select an item of for viewing, listening, or other uses via input, which may take the form of keypad, scroll, or other input device(s) or combinations thereof. When digital content is selected, the processor 710 may pass information. The content and PSI/SI may be passed among functions within the receiver using the bus 704.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 9. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Reaching out for help during an emergency situation becomes easier for the primary emergency contact 114, secondary emergency contact 116, and the person in distress 102. Reaching out for help within the vicinity of the target registered user device 104 will alert the plurality of associated registered users, thus reducing the parents stress.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A server for tracking a location of a plurality of associated registered user devices held by a plurality of associated registered users within a vicinity of a location of a target registered user device held by a person in distress to communicate with an associated registered user within said vicinity during an emergency situation, wherein said server comprises:
a server memory that stores an associated registered user database, and a first set of modules, wherein said associated registered user database stores contact information of a plurality of associated registered users who are associated with target users; and
a server processor that executes said first set of modules, wherein said first set of modules comprises;
a target registered user location obtaining module implemented by said server processor that obtains a location of said target registered user device on receiving an emergency indication from said target registered user device;
an associated registered user location module implemented by said server processor that periodically obtains locations of a plurality of associated registered users associated with a plurality of target registered users, wherein said target registered users and said associated registered users are registered with said server;
a relative distance calculation module implemented by said server processor that calculates a plurality of distances of said plurality of associated registered user devices in a vicinity of said location of said target registered user device;
a vicinity graph module implemented by said server processor that generates a graphical representation of locations of registered users in said vicinity of said target registered user device, wherein said vicinity graph module comprises;
a target registered user location representation module implemented by said server processor that displays said location of said target registered user device on said graphical representation;
a registered users location module implemented by said server processor that displays locations of said plurality of associated registered user devices on said graphical representation;
a registered users distance calculation module implemented by said server processor that calculates a plurality of distances of said plurality of associated registered user devices from said location of said target registered user device on said graphical representation;
a graphical representation communication module that communicates said graphical representation to at least one of (i) a primary emergency associated registered user device associated with said target registered user, or (ii) a secondary emergency associated registered user device associated with said target registered user; and
a selected associated registered user information communication module that obtains a selection of at least one selected associated registered user from said plurality of associated registered users within said vicinity, based on a selection corresponding to said location of said selected associated registered user on said graphical representation on at least one of (i) said primary emergency user device, or (ii) said secondary emergency user device, and communicates a contact information of said selected associated registered user to at least one of said (i) primary emergency user device, or (ii) secondary emergency user device to enable placing a call to said selected associated registered user.

2. The server of claim 1, wherein said target registered user device enables said person in distress to communicate with at least one of (i) said plurality of devices, (ii) said primary emergency user device, or (iii) said secondary emergency user device by sending a voice message.

3. The server of claim 1, further comprising communicating said location of said target registered user device on receiving said emergency indication from said target registered user device when said call to said selected associated registered user is placed from at least one of (i) said primary emergency user device, or (ii) said secondary emergency user device.

4. The server of claim 1, wherein (i) a message, or (ii) a reply message comprises at least one of (a) a SOS call, (b) a text message, (c) a voice message, or (d) a push message.

5. One or more non-transitory computer readable storage mediums storing one or more sequences of instructions, which when executed by one or more processors, causes tracking a location of a plurality of associated registered users seeking help during an emergency situation, by performing steps of:
receiving a request to identify a location of a target registered user device from at least one of (i) a primary emergency user device, or (ii) a secondary emergency user device when (i) said primary emergency user device, or (ii) said secondary emergency user device receives a message from a target registered user device;
obtaining said location of said target registered user device at periodic intervals;
calculating a plurality of distances of a plurality of associated registered user devices associated with a plurality of associated registered users from said location of said target registered user device;
generating a graphical representation that comprises (a) said location of said target registered user device, (b) locations of said plurality of associated registered user devices associated with said plurality of associated registered users, (c) distances of said plurality of associated registered user devices associated with said plurality of associated registered users from said location of said target registered user device, (d) names of said plurality of associated registered users;
communicating said graphical representation to at least one of (i) said primary emergency user device, or (ii) said secondary emergency user device;
obtaining a selection of at least one selected associated registered user from said plurality of associated registered users, based on a selection corresponding to a location of said selected associated registered user on said graphical representation on at least one of (i) said primary emergency user device, or (ii) said secondary emergency user device; and
obtaining a contact information of said selected associated registered user.

6. A primary emergency user device for tracking a location of a plurality of associated registered users to seek help during an emergency situation of a person in distress, comprising
a distress signal obtaining module that obtains a message from a target registered user device;
a person in distress location information requesting module that communicates a request to a server to identify a location of said target registered user device, wherein said location is updated at periodic intervals;
a person in distress location information obtaining module that obtains said location of said person in distress from said server at periodic intervals; and
a graphical representation module that displays a graphical information that is obtained from said server, said information of said plurality of associated registered users to seek help from said plurality of associated registered users when said person in distress is in said emergency situation, wherein said information of said plurality of associated registered users comprise at least one of (a) a contact information of said plurality of associated registered users, (b) locations of said plurality of associated registered users, and (c) a distance between said plurality of associated registered users and said target registered user device.

7. The primary emergency user device of claim 6, wherein said message comprises at least one of (a) a voice call, (b) a SOS call, (c) a SMS, or (d) a push message.

8. The primary emergency user device of claim 6, wherein an alarm continuously sounds on said primary emergency user device until said alarm is dismissed by a primary emergency contact.

9. The primary emergency user device of claim 6, wherein said primary emergency user device comprises any one of (i) a mobile phone, (ii) a Smartphone, (iii) a personal computer, (iv) a tablet, or (v) a notebook.

10. The primary emergency user device of claim 6, wherein said message is immediately transferred to a secondary emergency user device when said primary emergency contact does not receive the call.

11. The primary emergency user device of claim 6, wherein said server comprises
a server memory that stores an associated registered user database, and a first set of modules, wherein said associated registered user database stores contact information of a plurality of associated registered users who are associated with target users; and
a server processor that executes said first set of modules, wherein said first set of modules comprises;
a target registered user location module implemented by said server processor that obtains a location of said target registered user device on receiving an emergency indication from said target registered user device;
an associated registered user location obtaining module implemented by said server processor that periodically obtains locations of a plurality of associated registered users associated with a plurality of target registered users, wherein said target registered users and said associated registered users are registered with said server;
a relative distance calculation module implemented by said server processor that calculates a plurality of distances of said plurality of associated registered user devices in a vicinity of said location of said target registered user device;
a vicinity graph module implemented by said server processor that generates a graphical of locations of registered user in said vicinity of said target registered user device;
a graphical representation communication module that communicates said graphical representation to at least one of (i) a primary emergency associated registered user device associated with said target registered user, or (ii) a secondary emergency associated registered user device associated with said target registered user; and
a selected associated registered user information communication module that obtains a selection of at least one selected associated registered user from said plurality of associated registered users within said vicinity, based on a selection corresponding to said location of said selected associated registered user on said graphical representation on at least one of (i) said primary emergency user device, or (ii) said secondary emergency user device, communicates a contact information of said selected associated registered user to at least one of said (i) primary emergency user device, or (ii) secondary emergency user device to enable placing a call to said selected associated registered user.

12. The primary emergency user device of claim 11, wherein said graphical representation modules comprises;
a target registered user location representation module implemented by said server processor that displays said location of said target registered user device on said graphical representation;
a registered users location module implemented by said server processor that displays locations of said plurality of associated registered user devices on said graphical representation; and
a registered users distance calculation module implemented by said server processor that calculates a plurality of distances of said plurality of associated registered user devices from said location of said target registered user device on said graphical representation.

13. The primary emergency user device of claim 6, wherein (i) a message, or (ii) a reply message comprises at least one of (a) a SOS call, (b) a text message, (c) a voice message, or (d) a push message.
